(19) United States
(12) Patent Application Publication
(10) Pub. No.: US 2011/0302559 A1
(43) Pub. Date: Dec. 8, 2011

(54) METHOD AND APPARATUS FOR LEVERAGING PATH-PROGRAM ANALYSIS FOR EFFECTIVE STATIC WHOLE-PROGRAM ANALYSIS

(76) Inventor: Mayur Naik, Berkeley, CA (US)

(21) Appl. No.: 12/794,396

(22) Filed: Jun. 4, 2010

(51) Int. Cl. G06F 9/44

(52) U.S. Cl. 717/124

(57) ABSTRACT

A static thread-escape analysis that is flow-sensitive and context-sensitive for precision and is also scalable through the use of path-program analysis is provided. Path-program analysis precisely analyzes a finite set of finite paths, one at a time, instead of analyzing all paths, and infers an abstraction hint tailored to answering a single thread-local query at a time, instead of simultaneously answering all queries. A static whole-program analysis is subsequently performed using the computed abstraction hint in an attempt to prove the query thread-local for all paths.

### FIELD

This disclosure relates to multi-threaded software applications and in particular to tools for testing multi-threaded software applications.

### BACKGROUND

In a multithreaded program, different threads can handle different tasks and proceed in parallel to improve speed and efficiency. Threads are tasks that run independently of one another within the context of a process. Threads operate in the same manner as processes, and similar to processes, share a processor. Each thread is a different stream of control that can execute its instructions independently, enabling a multithreaded process to perform numerous tasks concurrently. A thread shares code and data with the parent process but has its own unique stack and architectural state that includes the instruction pointer.

Sharing of resources (code and data) amongst threads can introduce common programming errors such as storage conflicts and other race conditions. Finding the source of the programming errors is difficult as the programming errors are often non-deterministic.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of a system that includes an embodiment of a program analyzer for a multi-threaded program according to the principles of the present invention;

FIG. 2 is a block diagram illustrating an embodiment of the multi-threaded program analyzer to perform thread-escape analysis on a multi-threaded Java program according to the principles of the present invention;

FIG. 3 is a flow graph illustrating a method for performing thread-escape analysis by the multi-threaded program analyzer shown in FIG. 2;

FIG. 4 is an example of a whole-program;

FIG. 5 is an example of a path-program of the whole-program shown in FIG. 4;

FIG. 6 depicts the abstract states at program points p1, p2, and p3 for the path-program shown in FIG. 5 using abstraction hint {h1,h2,h3,h4};

FIG. 7 depicts the abstract states at program points p1, p2, and p3 for the path-program shown in FIG. 5 using abstraction hint {h1,h2}; and

FIG. 8 depicts the abstract states at program points p1, p2, and p3 for the path-program shown in FIG. 5 using abstraction hint {h3,h4}.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

Threading an application may introduce errors that are hard to detect and reproduce. A majority of the effort in threading applications falls in the design, implementation and the debug phases of the development cycle. Threading effort depends on the software programmer's experience in threading applications and knowledge of the application that is being threaded.

Threading tools for a multi-threaded software program (application) may be used to locate hard-to-catch programming errors and potential programming errors such as deadlocks and potential deadlocks, data races and thread stalls in the multi-threaded application. A deadlock is an unintended condition in a shared-memory multi-threaded program in which a set of threads blocks forever because each thread in a set of threads waits to acquire a lock being held by another thread in the set of threads.

Static thread-escape analysis may be used to determine whether an object can be proven to be restricted only to a single thread. Thread-escape analysis is typically used by threading tools to determine which data (object) in a shared-memory, multi-threaded program may “thread-escape”, that is, may become accessible from more than one thread. Data (object) that is not accessible from more than one thread is typically referred to as “thread-local” data. A compiler can use the determination that an object is thread-local as the basis for optimization. For example, if an object is thread-local, operations can be performed on the object without the use of synchronization (locks). Information about which data is thread-local can also be used to reduce false positives reported by static analyses for finding concurrency defects such as races and deadlocks; to reduce the run-time overhead of software transactional memory and that of dynamic analyses for finding concurrency defects; to support more efficient memory allocators and garbage collectors for multi-threaded programs; and to optimize multi-threaded programs under sequentially consistent memory models.

Prior art static thread-escape analyses are either flow-insensitive and context-insensitive, which are scalable but imprecise, or flow-sensitive and context-sensitive which are precise but not scalable.

An embodiment of the present invention provides a static thread-escape analysis that is flow-sensitive and context-sensitive for precision and is also scalable through the use of path-program analysis. Path-program analysis precisely analyzes a finite set of finite control-flow paths, one at a time, instead of simultaneously analyzing all control-flow paths, and infers a parsimonious heap abstraction tailored to answering a single thread-local query at a time, instead of simultaneously answering all queries.

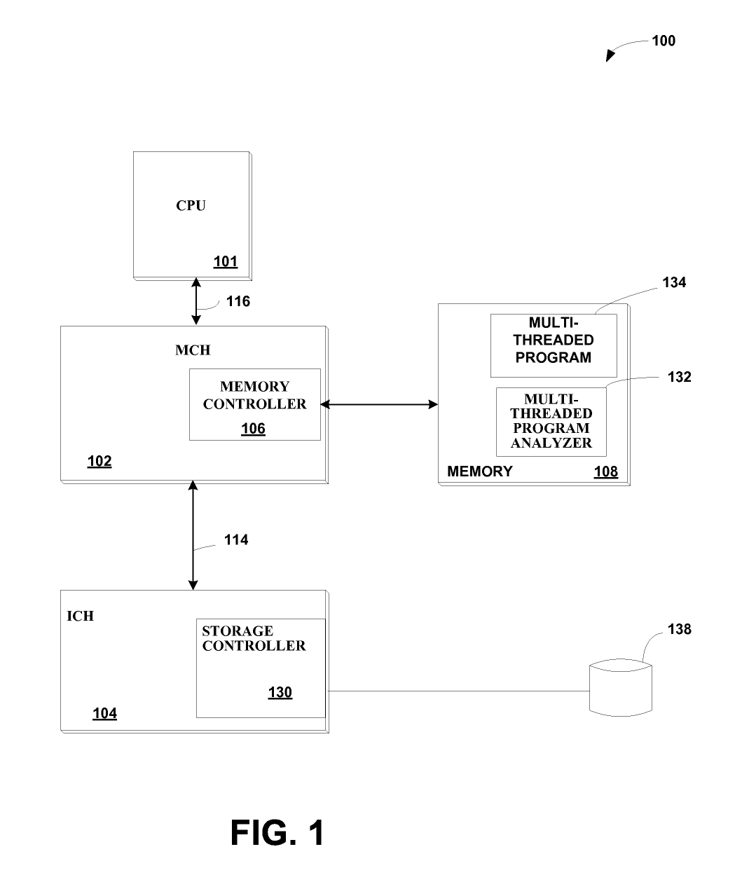

FIG. 1 is a block diagram of a system 100 that includes an embodiment of a multi-threaded program analyzer 132 according to the principles of the present invention. The system 100 includes a Central Processing Unit (CPU) 101 including a plurality of core processors, a Memory Controller Hub (MCH) 102 and an I/O Controller Hub (ICH) 104. The MCH 102 controls communication between the CPU 101 and memory 108.

The CPU 101 may be any one of a plurality of processors such as a multi-core processor such as Intel® Pentium D, Intel® Xeon® processor, Intel® Core® Duo processor or Intel® Core 2 Duo® Conroe E6600 processor or any other multi-core processor.

The memory 108 may be Dynamic Random Access Memory (DRAM), Static Random Access Memory (SRAM), Synchronized Dynamic Random Access Memory (SDRAM), Double Data Rate 2 (DDR2) RAM or Rambus Dynamic Random Access Memory (RDRAM) or any other type of memory.

The ICH 104 may be coupled to the MCH 102 using a high speed chip-to-chip interconnect 114 such as Direct Media Interface (DMI). DMI supports 2 Gigabit/second concurrent transfer rates via two unidirectional lanes. The CPU 101 and MCH 102 communicate over a system bus 116.

The ICH 104 may include a storage controller 130 for controlling communication with a storage device 138 coupled to the ICH 104.

The multi-threaded program analyzer 132 performs static (that is, compile time) whole-program analysis on a multi-threaded program 134 that can be stored in memory 108 or on the storage device 138.

An embodiment will be described for thread-escape analysis for a Java multi-threaded program. However, the invention is not limited to Java multi-threaded programs. Furthermore, embodiments may be applied to static analysis other than thread-escape analysis.

In an embodiment of thread-escape analysis according to the principles of the present invention, a thread-local query (p, v) is used to determine if a variable v of reference type at a program point p always points to objects reachable from at most one thread at that program point. In a Java embodiment, an object is reachable from multiple threads if it is reachable from some static field, that is, a global variable, or from the “this” argument of the method java.lang.Thread.start( ) If an object is reachable from at most one thread, it is thread-local. Otherwise, it is thread-escaping.

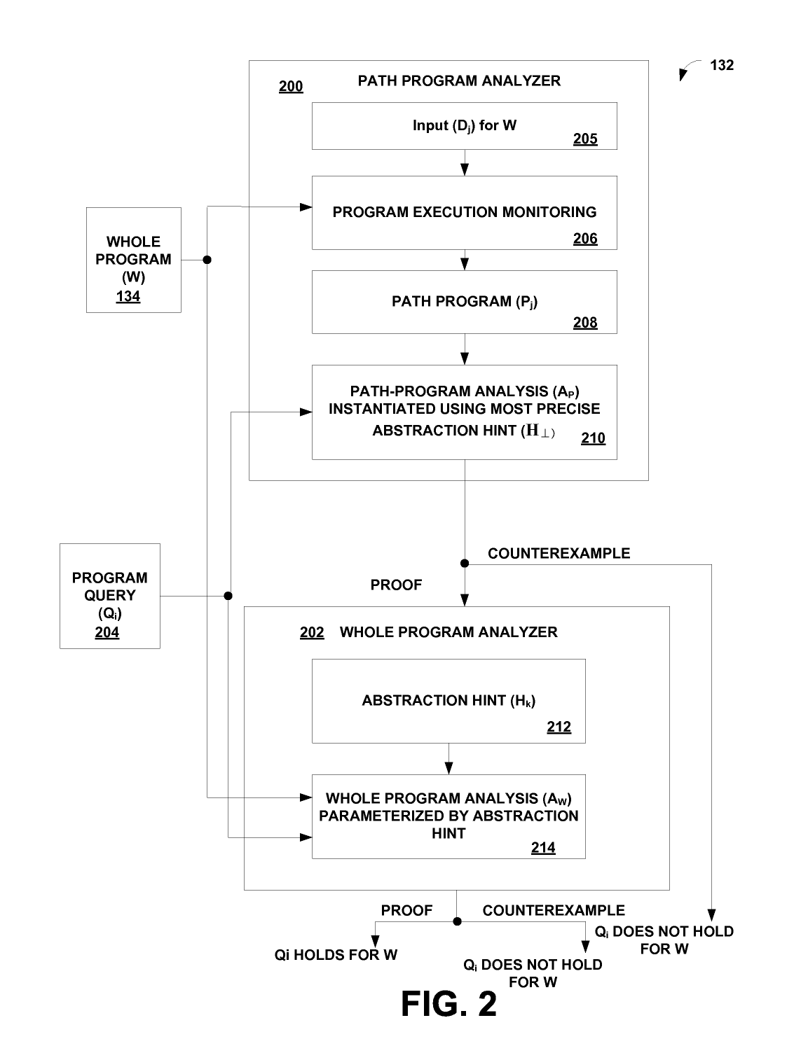

FIG. 2 is a block diagram illustrating an embodiment of the multi-threaded program analyzer 132 to perform thread-escape analysis on a multi-threaded Java program 134 according to the principles of the present invention. The multi-threaded program analyzer 132 has two inputs, a whole-program (W) 134 and a finite set of program queries (Qᵢ) 204 of a particular kind The multi-threaded program analyzer 132 has an output that indicates whether each Qᵢ holds for W. In the embodiment shown, the multi-threaded program W is a complete multi-threaded Java program and queries Qᵢ are thread-local queries. The analysis is a flow-sensitive and summary-based context-sensitive thread-escape analysis for a multi-threaded Java program that uses an object allocation site-based heap abstraction A heap in a Java program is an area of memory that is dynamically allocated for use in the Java program during the runtime of the program. Object allocation sites are points in a Java program at which memory is dynamically allocated. An object allocation site-based heap abstraction is an abstraction of the heap that uses a separate partition to represent all objects allocated at the same site. Thus, this abstraction can distinguish between objects allocated at different sites but not between objects allocated at the same site.

The multi-threaded program analyzer 132 includes a path-program analyzer 200 and a whole-program analyzer 202. The combination of the path-program analyzer 200 and the whole-program analyzer 202 provides a means for efficiently determining whether a given query (Qᵢ) 204 of interest holds on all control-flow paths of the given whole-program (W) 134. Both the path-program analyzer 200 and the whole-program analyzer 202 perform a given static analysis A which is parameterized by an abstraction hint H. In the embodiment shown, an abstraction hint H is a set of object allocation sites relevant to proving a query thread-local. Static analysis A uses a single partition to represent objects allocated at sites not included in the abstraction hint. Thus, the larger the abstraction hint, the more distinctions are possible between objects, and the more precise (and less scalable) is static analysis A.

The path-program analyzer 200 applies static analysis A instantiated using the most precise (and least scalable) abstraction hint (H_{⊥}) 210, where H_{⊥} is the set of all object allocation sites, to each path-program (Pⱼ) 208 in a finite set of path-programs (control-flow paths) in the whole-program W. Each path-program Pⱼ can be obtained by running the whole-program W on a different input (Dⱼ) 205. Path-program analyzer 200 is scalable despite using the most precise abstraction hint H_{⊥} because each path-program Pⱼ is a single finite trace whereas the whole-program W typically has multiple unbounded traces (due to loops or recursion).

The result of path-program analyzer 200 on path-program Pⱼ can be used to determine whether each query Qᵢ holds on that path-program. If the result of the path-program analyzer 200 determines that a query Qᵢ does not hold on a path-program Pⱼ, it implies that whole-program analyzer 202 will not be able to prove that query Qᵢ holds for whole-program W, regardless of the abstraction hint used to instantiate it. Thus, it is not necessary to run whole-program analyzer 202 to attempt to prove that query Qᵢ holds for whole-program W. Hence, the reported result is that query Qᵢ does not hold for whole-program W because it does not hold on path-program Pⱼ.

If the result of path-program analyzer 200 is that query Qᵢ holds on all the given path-programs Pⱼ, then it cannot be concluded that query Qᵢ holds for whole-program W. This is because the given path-programs Pⱼ are not required to, and typically do not, have complete coverage of whole-program W. In this case, the results of the path-program analyzer 200 on path-programs Pⱼ are combined to compute the least precise (and most scalable) abstraction hint (Hₖ) 212 such that static analysis A instantiated using abstraction hint Hₖ also concludes that query Qᵢ holds on all path-programs Pⱼ. Abstraction hint Hₖ is highly dependent on query Qᵢ, and different queries Qᵢ yield potentially different abstraction hints Hₖ's.

After path-program analyzer 200 has computed abstraction hint Hₖ, whole-program analyzer 202 applies static analysis A instantiated using abstraction hint Hₖ to whole-program W, in an attempt to prove that query Qᵢ holds for whole-program W. The use of abstraction hint Hₖ instead of the most precise abstraction hint H_{⊥} ensures that the whole-program analyzer 202 is scalable. The result of the whole-program analyzer 202 (either that Qᵢ holds for W or that Qᵢ does not hold for W) is reported. If it reports that Qᵢ holds for W, then it is indeed the case that Qᵢ holds for W in reality (that is, whole-program analyzer 202 does not produce false negatives). On the other hand, if it reports that Qᵢ does not hold for W, then Qᵢ may or may not hold for W in reality (that is, whole-program analyzer 202 may produce false positives).

The precision of the multi-threaded program analyzer 132 is dependent upon the coverage of the given path-programs Pⱼ. Poor coverage may yield an abstraction hint Hₖ that is very imprecise, that is, unable to prove that query Qᵢ holds for whole-program W even though it does in fact hold. Reasonable coverage can yield an abstraction hint Hₖ as precise as the most precise abstraction hint H_{⊥}.

The advantages of an embodiment of the multi-threaded program analyzer 132 according to the principles of the present invention include soundness, precision and scalability characteristics. The multi-threaded program analyzer 132 has the soundness characteristic because it does not have false negatives, that is, it does not claim that a query holds for a program when it does not in fact hold. Regarding the precision characteristic, the multi-threaded program analyzer 132 has a low false-positive rate, that is, it rarely claims that a query does not hold for a program when it does in fact hold. In addition, the multi-threaded program analyzer 132 is scalable, allowing the analysis to be applied to large, real-world programs, for example, the multi-threaded program analyzer 132 does not run out of resources such as run-time memory.

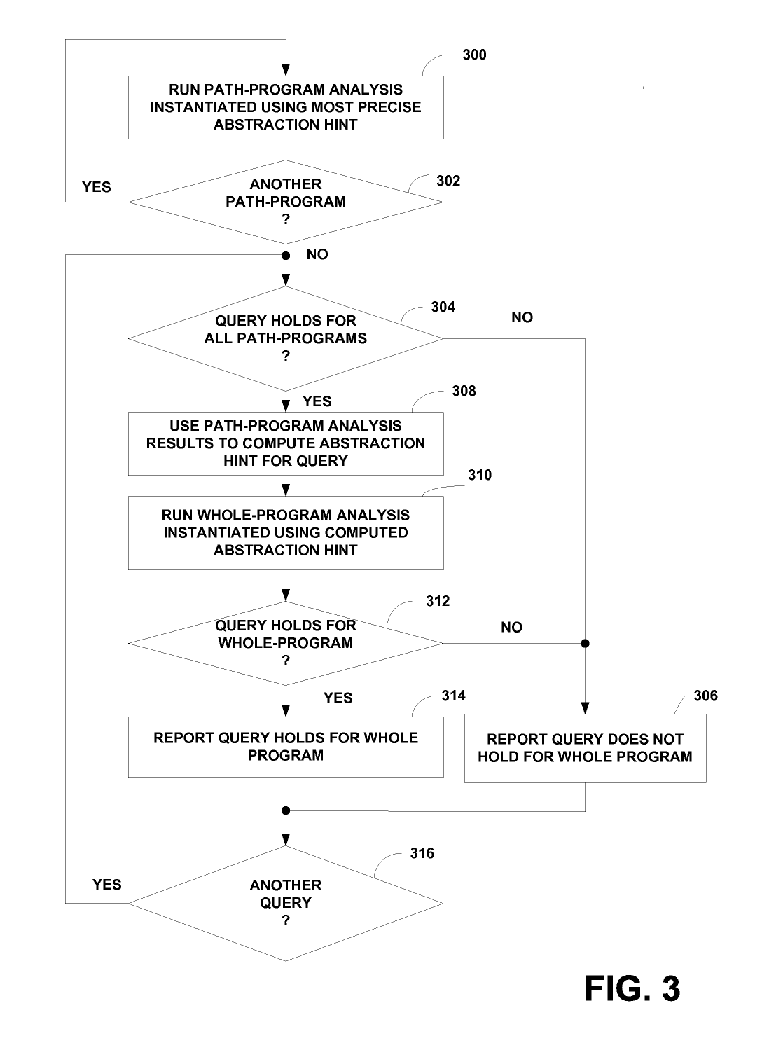

FIG. 3 is a flow graph illustrating a method for performing thread-escape analysis by the multi-threaded program analyzer shown in FIG. 2.

At block 300, the path-program analyzer 200 runs the given static analysis instantiated using the most precise (and least scalable) abstraction hint on a given path-program (control-flow path) in the whole-program 134.

At block 302, if there is another path-program, processing continues with block 300, if not, processing proceeds to block 304.

At block 304, the path-program analysis results computed by the path-program analyzer 200 at block 300 are used to determine if the given query holds on all of the considered path-programs. If the query holds, then processing continues with block 308, if not, processing continues with block 306.

At block 306, it is reported that the query does not hold for the whole-program 134, since it does not hold on some path-program, and processing continues with block 316.

At block 308, the path-program analyzer 200 computes an abstraction hint that embodies the reason why the given query holds on all the given path-programs, and processing continues with block 310.

At block 310, the whole-program analyzer 202 runs the given static analysis instantiated using the abstraction hint computed at block 308, in an attempt to prove that the given query holds on all control-flow paths of the whole-program 134, and processing continues with block 312.

At block 312, the whole-program analysis result computed by the whole-program analyzer 202 at block 310 is used to determine if the given query holds on all control-flow paths of the whole-program 134. If the query holds, then processing continues with block 314, if not, processing continues with block 306.

At block 314, it is reported that the given query holds for the whole-program 134, and processing continues with block 316.

At block 316, if there is another query, processing proceeds to block 304, if not, the algorithm terminates.

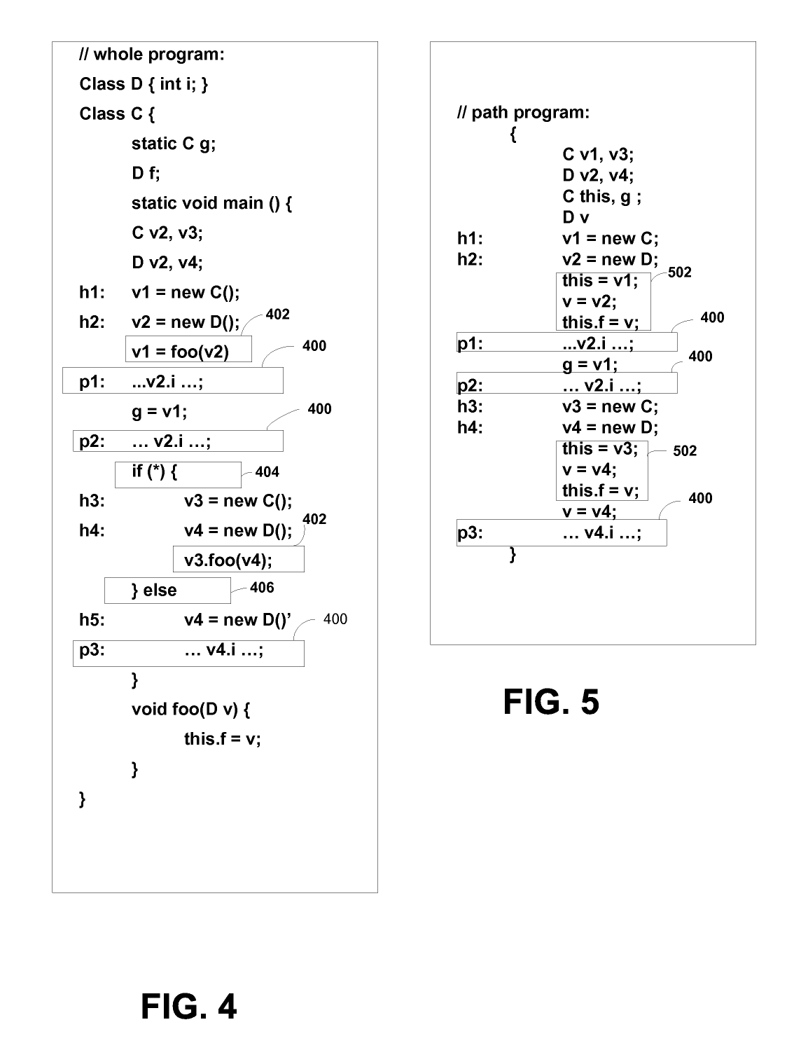

FIG. 4 is an example of a whole-program (Java program). Three program points (p1, p2, p3) 400 are identified in the whole-program. The whole-program includes two calls to method foo 402 and four variables labeled v1, v2, v3 and v4. The whole-program is not multi-threaded. However, most thread-escape analyses consider data reachable from static fields which are globally visible as thread-escaping, regardless as to whether the data is actually accessed by multiple threads. For example, field g of class C in the Java program shown in FIG. 4 is a static field that is globally visible.

At each of the three program points (p1, p2, p3) 400 there is a statement that reads or writes instance field i of the object of class D pointed to either by variable v2 or variable v4. Queries (Q) in the form “thread-local(program point, variable)” are used to determine if the specified variable always points to thread-local data at the specified program point.

More formally, a thread-local query (Q) asks if variable (v) in scope at program point (p) is thread-local at program point (p) in a whole-program (W) or a path-program (P), in the following sense: “In every execution, whenever a thread reaches program point (p) and the thread's copy of variable (v) points to object (o), is object (o) reachable from at most one thread in every state of that execution upto and including the current state?”. An object is reachable from at most one thread in a state if it is not reachable from any source of escapement in that state. Sources of escapement are (1) static fields and (2) the “this” argument of the start( ) method of class java.lang.Thread, which spawns a new thread. The object becomes reachable from all threads in case (1) and from at least the spawning and spawned threads in case (2).

In the example Java program shown in FIG. 4, an object that is reachable either directly or via the heap from static field g is thread-escaping. If the object is not reachable from static field g, the object is thread-local.

The Java program shown in FIG. 4 includes an “if” statement 404 and an “else” statement 406 which provide two different program paths, that is, the “if” program path and the “else” program path.

FIG. 5 is an example of a path-program of the whole-program shown in FIG. 4. A path-program P is a finite execution of a whole-program. Specifically, it is a finite sequence of program points 400 in a whole-program that starts at the unique entry point of main, respects intra- and inter-procedural control flow in the whole-program, and in which all method calls are inlined. Method calls are inlined by replacing each call to a method by the body of that method. The statement at each point in a path-program is an intra-procedural statement, that is, it is not a call site or a return, though the path-program captures their effect by introducing copy assignments between arguments and return results.

The path-program shown in FIG. 5 corresponds to the execution in which the “if” branch is taken in the main method of the whole-program shown in FIG. 4. Both calls to method foo are inlined in the path-program, that is, call sites 402 in FIG. 4 are replaced in FIG. 5 by the body 502 of method foo. Three queries for the path-program shown in FIG. 5 are shown below in Table 1.

TABLE 1

Q1 = thread-local(p1, v2)
Q2 = thread-local(p2, v2)
Q3 = thread-local(p3, v4)

Each query in Table 1 is in the form “thread-local(p, v)” and asks if variable (v) always points to thread-local data at program point (p). At each program point (p1, p2, p3) 400 is a statement that reads or writes instance field i of the object of class D pointed to by variables v2, v2, and v4, respectively. For example, the statement at program point p1 is “v2.i”. In an embodiment, a race detector can use the queries (Q1, Q2, and Q3) to determine if the statements at particular program points always accesses thread-local data and thus cannot be involved in any races.

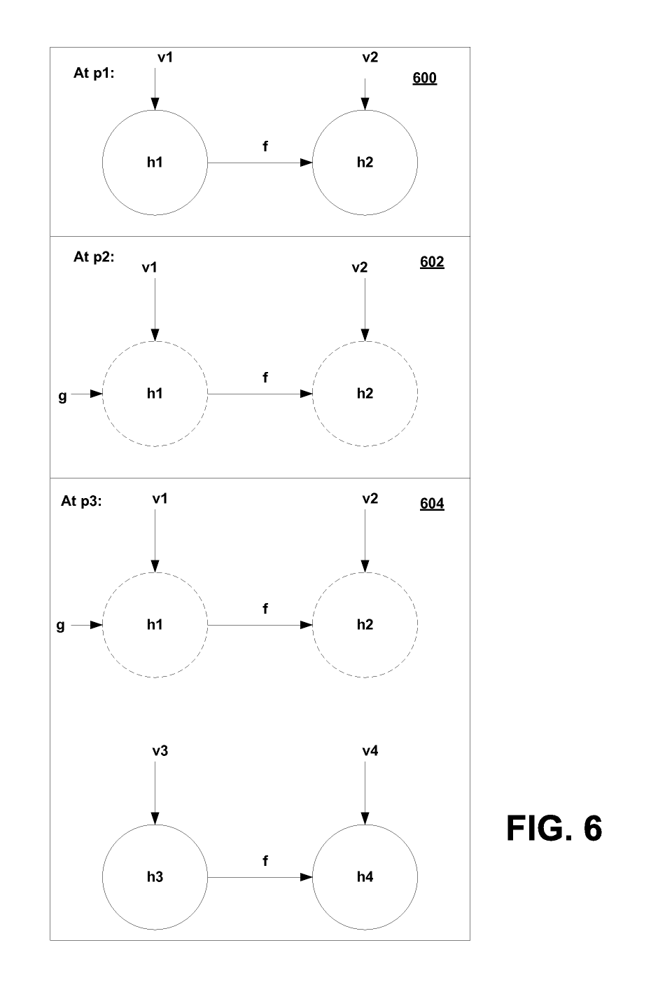

FIG. 6 depicts the abstract states at program points p1 600, p2 602, and p3 604 computed for the path-program shown in FIG. 5 by the path-program analyzer, which is a flow-sensitive and summary-based context-sensitive thread-escape analysis instantiated using the most precise abstraction hint H_{⊥}={h1,h2,h3,h4}. An abstract state contains an edge v->h whenever variable v may point to an object allocated at site h, as well as an edge h->h′ labeled f whenever instance field f of an object allocated at site h may point to an object allocated at site h′. Each site h is denoted either in a solid circle, indicating that all objects allocated at that site are thread-local in that state, or in a dotted circle, indicating that some object allocated at that site may thread-escape in that state.

The abstract states 600, 602, 604 shown in FIG. 6 are used to determine if queries Q1, Q2, and Q3 respectively hold for the path-program shown in FIG. 5.

Query Q1 holds for the path-program shown in FIG. 6 because, as shown at abstract state 600, variable v2 may point only to an object allocated at site h2, and this site is in a solid circle, denoting that no object allocated at that site is reachable from static field g at program point p1. The path-program analyzer computes abstraction hint H1={h1,h2} which the whole-program analyzer will subsequently use in attempting to prove that query Q1 holds for the whole-program shown in FIG. 4.

Query Q2 does not hold for the path-program shown in FIG. 5 because, as shown at abstract state 602, variable v2 may point to an object allocated at site h2, and this site is in a dotted circle, denoting that some object allocated at that site may be reachable from static field g at program point p2. Thus, it is rightly reported that query Q2 does not hold for the whole-program shown in FIG. 4.

Query Q3 holds for the path-program shown in FIG. 5 because, as shown at abstract state 604, variable v4 may point only to an object allocated at site h4, and this site is in a solid circle, denoting that no object allocated at that site is reachable from static field g at program point p3. The path-program analyzer computes abstraction hint H3={h3,h4} which the whole-program analyzer will subsequently use in attempting to prove that query Q3 holds for the whole-program shown in FIG. 4.

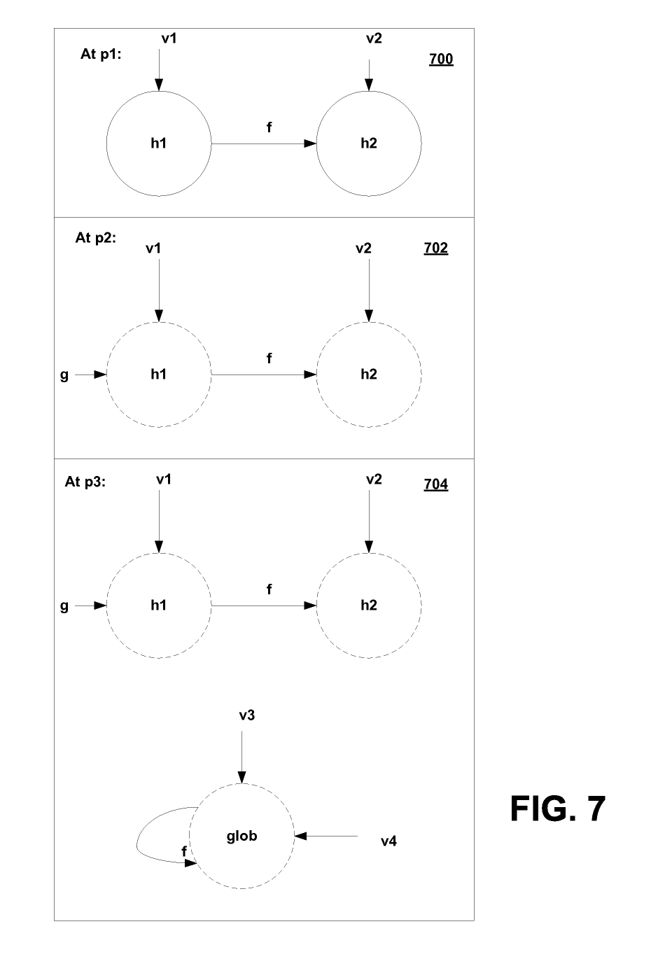

FIG. 7 depicts the abstract states at program points p1 700, p2 702, and p3 704 computed for the whole-program shown in FIG. 4 by the whole-program analyzer, which is a flow-sensitive and summary-based context-sensitive thread-escape analysis, instantiated using abstraction hint H1={h1,h2}, in an attempt to prove that query Q1 holds for the whole-program. Objects allocated at sites other than those in abstraction hint H1, namely h3, h4, and h5, are abstracted by a hypothetical site denoted “glob”. The whole-program analyzer succeeds in proving that query Q1 holds for the whole-program shown in FIG. 4 because, as shown by abstract state 700, variable v2 may point only to an object allocated at site h2, and this site is in a solid circle, denoting that no object allocated at that site is reachable from static field g at program point p1. Thus, it is rightly reported that query Q1 holds for the whole-program shown in FIG. 4.

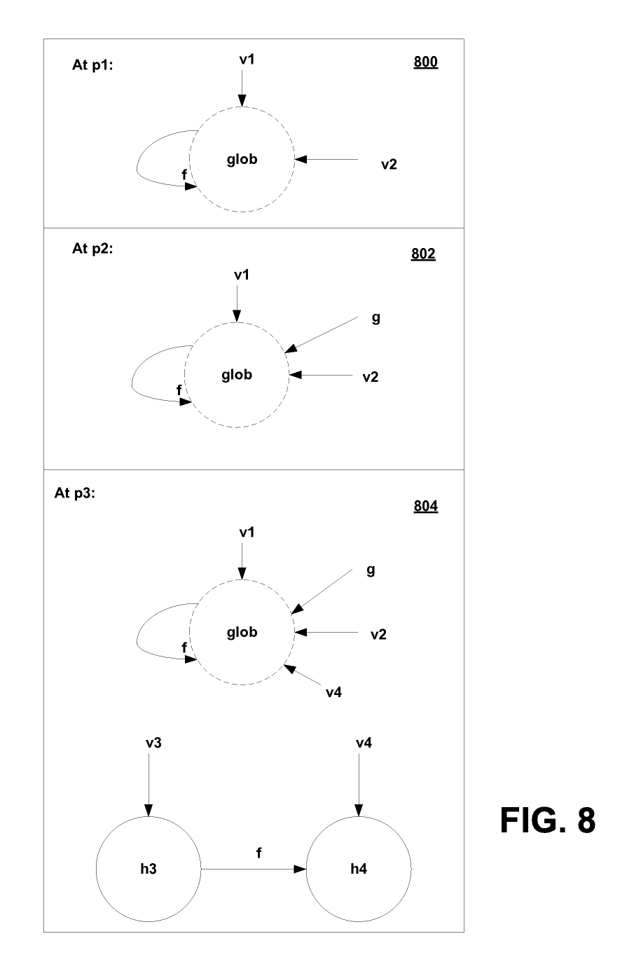

FIG. 8 depicts the abstract states at program points p1 800, p2 802, and p3 804 computed for the whole-program shown in FIG. 4 by the whole-program analyzer, which is a flow-sensitive and summary-based context-sensitive thread-escape analysis, instantiated using abstraction hint H3={h3,h4}, in an attempt to prove that query Q3 holds for the whole-program. Objects allocated at sites other than those in abstraction hint H3, namely h1, h2, and h5, are abstracted by a hypothetical site denoted “glob”. The whole-program analyzer fails in proving that query Q3 holds for the whole-program shown in FIG. 4 because, as shown by abstract state 804, variable v4 may point to an object allocated at site “glob”, and this site is in a dotted circle, denoting that some object allocated at that site may be reachable from static field g at program point p3. Thus, it is falsely reported that query Q3 does not hold for the whole-program shown in FIG. 4. This is an example of a false-positive resulting from the lack of coverage of all paths in the whole-program shown in FIG. 4 by the single path-program shown in FIG. 5. In particular, the path-program shown in FIG. 5 takes the “if” branch in the whole-program shown in FIG. 4, and so site h5, located in the “else” branch, is not included in abstraction hint H3 even though it is relevant to proving query Q3.

It will be apparent to those of ordinary skill in the art that methods involved in embodiments of the present invention may be embodied in a computer program product that includes a computer usable medium. For example, such a computer usable medium may consist of a read only memory device, such as a Compact Disk Read Only Memory (CD ROM) Disk or conventional ROM devices, or a computer Diskette, having a computer readable program code stored thereon.

While embodiments of the invention have been particularly shown and described with references to embodiments thereof, it will be understood by those skilled in the art that various changes in form and details may be made therein without departing from the scope of embodiments of the invention encompassed by the appended claims.

1. A method comprising:
performing whole-program analysis on an application by:
performing path-program analysis on a finite set of finite control-flow paths in the application;
generating an abstraction hint based on the result of the path-program analysis; and
using the abstraction hint to perform whole-program analysis to determine if a query deemed to hold by the path-program analysis on the finite set of finite control-flow paths also holds on all control-flow paths in the application.

2. The method of claim 1, wherein the path-program analysis is based on a finite number of queries.

3. The method of claim 1, wherein the path-program analysis infers an abstraction hint by answering a single query at a time.

4. The method of claim 1, wherein the abstraction hint is based on results of queries deemed to hold by the path-program analysis.

5. The method of claim 1, wherein the application is a Java application.

6. The method of claim 1, wherein the path-program analysis is performed on an if program path in the application.

7. The method of claim 1, wherein the path-program analysis is performed on an else program path in the application.

8. An apparatus comprising:
a processor; and
a memory to store a program analyzer, the program analyzer comprising:
a path-program analyzer to perform path-program analysis on a finite set of finite control-flow paths in the application and to generate an abstraction hint based on the result of the path-program analysis; and
a whole-program analyzer to use the abstraction hint to perform whole-program analysis to determine if a query deemed to hold by the path-program analysis on the finite set of finite control-flow paths also holds on all control-flow paths.

9. The apparatus of claim 8, wherein the path-program analysis is based on a finite number of queries.

10. The apparatus of claim 8, wherein the path-program analysis infers an abstraction hint by answering a single query at a time.

11. The apparatus of claim 8, wherein the abstraction hint is based on results of queries deemed to hold by the path-program analysis.

12. The apparatus of claim 8, wherein the application is a Java application.

13. The apparatus of claim 8, wherein the path-program analysis is performed on an if program path in the application.

14. The apparatus of claim 8, wherein the path-program analysis is performed on an else program path in the application.

15. An article including a machine-accessible medium having associated information, wherein the information, when accessed, results in a machine performing:
performing whole-program analysis on an application by:
performing path-program analysis on a finite set of finite control-flow paths in the application;
generating an abstraction hint based on the result of the path-program analysis; and
using the abstraction hint to perform whole-program analysis to determine if a query deemed to hold by the path-program analysis on the finite set of finite control-flow paths also holds on all control-flow paths.

17. The article of claim 16, wherein the path-program analysis is based on a finite number of queries.

18. The article of claim 16, wherein the path-program analysis infers an abstraction hint by answering a single query at a time.

19. The article of claim 16, wherein the abstraction hint is based on results of queries deemed to hold by the path-program analysis.
